(19) United States
(12) Patent Application Publication
(10) Pub. No.: US 2013/0063225 A1
(43) Pub. Date: Mar. 14, 2013

(54) PHASE SHIFTER

(71) Applicants: Gangyi Deng, Shanghai (CN); Cong Chen, Shanghai (CN); Hanxing Xu, Shanghai (CN); Dongliang Xu, Shanghai (CN)

(72) Inventors: Gangyi Deng, Shanghai (CN); Cong Chen, Shanghai (CN); Hanxing Xu, Shanghai (CN); Dongliang Xu, Shanghai (CN)

(73) Assignee: Netop Technology Co., Ltd., Shanghai (CN)

(21) Appl. No.: 13/503,896

(22) PCT Filed: Oct. 28, 2010
(86) PCT No.: PCT/CN10/01716

§ 371 Date: Jul. 9, 2012

(30) Foreign Application Priority Data
Oct. 30, 2009 (CN) 200910209616.9

(51) Int. Cl. H01P 1/18

(52) U.S. Cl. 333/156

(57) ABSTRACT

The present invention discloses a phase shifter, which comprises at least two layered chambers, wherein, in each chamber two parallel-arranged metal guide sleeves and a U-shaped conductor are set, the two free ends of the U-shaped conductor are respectively inserted into the two metal guide sleeves, and the free ends of the U-shaped conductor move relatively to the metal guide sleeves so as to change the phase of the output signal of the phase shifter. Using the phase shifter provided in the present invention enables the phase control of each radiating element to be very convenient. Furthermore, the phase shifter is simple in structure and inexpensive.

### FIELD OF THE INVENTION

The present invention relates to an antenna member, more particularly to a phase shifter for a base station antenna.

### BACKGROUND OF THE INVENTION

In addition to a radiating element, a reflector plate and a feeding network, a phase shifter is one of the critical components of a phased antenna. In a base station antenna, the phase shifter is utilized mainly for adjusting the phase variation of the feeding network so as to shift the phase of each or each set of the radiating elements. As such, an inclination of a vertical beam or an angle of a horizontal beam can be changed. Thus, a more flexible optimization means is provided for wireless network operators to optimize the performance of the entire system.

At present, an integrated phase shifter (with one input and five outputs) with the expensive printed circuit board is used by some manufacturers, which makes the manufacturing cost extremely high and the phase of each radiating element not to be controlled. As a result, the performance of the antenna array is limited. Also, some of the manufacturers use an integrated air microstrip or air stripline, and the phase of each radiating element can be controlled by changing the dielectric constant between the air microstrip or air stripline and a ground plane. Although the lower loss may be achieved comparing to the phase shifter with an integrated printed circuit board, the performance of the antenna array is limited as well. Moreover, a completely-separated phase shifter is introduced by some manufacturers, which however causes too many internal elements in the antenna, thereby greatly increasing the assembly complexity of the antenna and further the cost of antenna.

U.S. patents U.S. Pat. No. 7,463,190 and U.S. Pat. No. 6,850,130 disclose an integrated phase shifter with one input and multiple outputs, respectively, in which these outputs are connected to the radiating elements through cables so as to change the tilt of the antenna radiating beam by controlling the phase variation of radiating elements. However, once the number of the radiating elements is larger than the number of output ports of the phase shifter, said phase shifter cannot control the phase of each of the radiating elements such that the feeding to the radiating elements has to be performed by groups, and therefore the performance of the antenna array is limited. At the same time, expensive printed circuit boards are utilized in both of the said phase shifters, which leads to the significant high costs and great loss.

### SUMMARY OF THE INVENTION

In consideration of the above-mentioned problems in the prior art, embodiments of the present invention provide a phase shifter, which can reduce the loss, lower the cost and enable the phase control of each radiating element to be very convenient.

To achieve the object described above, an aspect of the present invention provides a phase shifter comprising at least two layered chambers, wherein in each chamber two parallel-arranged metal guide sleeves and a U-shaped conductor are set, two free ends of the U-shaped conductor are respectively inserted into the two metal guide sleeves, and the free ends of the U-shaped conductor move relatively to the metal guide sleeves so as to change a phase of an output signal of the phase shifter.

To achieve the object described above, another aspect of the present invention provides a phase shifter comprising at least two layered phase shifter units, wherein in each phase shifter unit two parallel-arranged metal guide sleeves and a U-shaped conductor are set, two free ends of the U-shaped conductor are respectively inserted into the two metal guide sleeves, and the free ends of the U-shaped conductor move relatively to the metal guide sleeves so as to change a phase of an output signal of the phase shifter.

With the phase shifter of the embodiments of the present invention, the phase variation of a plurality of radiating elements is centralized-controlled in the manner of layered-arrangement, so as to enable the high integration level of the phase shifter and enable the phase control of each radiating element to be very convenient. The phase shifter of the present invention, with simple structure, low cost and phase shifting effect of high quality, can be applied widely in the feeding network of the phased antenna array in order to control the vertical beam and/or the horizontal beam of the antenna, such that the present invention provides better flexibility for the mobile telephone network to optimize the system performance.

### BRIEF DESCRIPTION OF THE DRAWINGS

FIG. 1 is a structurally perspective view of a first embodiment of a phase shifter of the present invention;

FIG. 2 is a front view of the phase shifter shown in FIG. 1;

FIG. 3 is a cutaway view of the phase shifter along a line A-A in FIG. 2;

FIG. 4 is a left side view of the phase shifter shown in FIG. 1;

FIG. 5 is a structurally schematic view of a second embodiment of a phase shifter of the present invention;

FIG. 6 is a structurally schematic view of a third embodiment of a phase shifter of the present invention.

### DETAILED DESCRIPTION ON THE EMBODIMENTS

Now, the detail description of the embodiments of the present invention will be made with reference to the accompanying drawings.

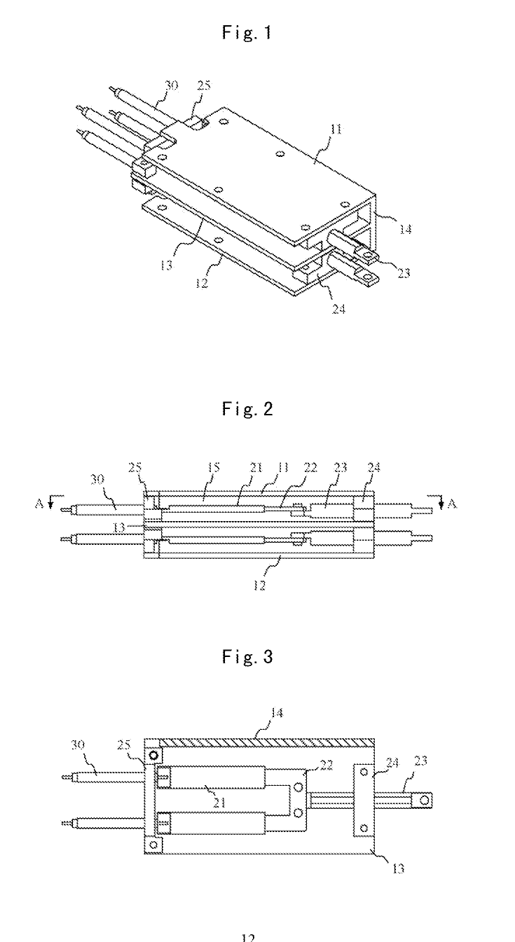

FIG. 1 is a structurally perspective view of a first embodiment of a phase shifter of the present invention; and FIG. 2 is a front view of the phase shifter shown in FIG. 1. In this embodiment, the phase shifter comprises two layered phase shifter units. In each phase shifter unit, two parallel-arranged metal guide sleeves 21 and a U-shaped conductor 22 are set. Two free ends of the U-shaped conductor 22 are respectively inserted into the two metal guide sleeves 21, and the free ends of the U-shaped conductor 22 move relatively to the metal guide sleeves 21 so as to change a phase of an output signal of the phase shifter.

In particular, the phase shifter includes an upper cover plate 11, a lower bottom plate 12, a side plate 14, and a partition plate 13. The upper cover plate 11, the lower bottom plate 12, the side plate 14, and the partition plate 13 are each made of metal. The upper cover plate 11 and the lower bottom plate 12 are provided so as to be parallel to each other and perpendicular to the side plate 14. The upper cover plate 11, the lower bottom plate 12 and the side plate 14 of the phase shifter form a metal housing. The partition plate 13 is provided between the upper cover plate 11 and the lower bottom plate 12, and is perpendicular to the side plate 14. The metal housing is divided as an E-shaped chamber by the partition plate 13, i.e. the metal housing is divided into two layered chambers 15 by the partition plate 13. Preferably, the upper cover plate 11, lower bottom plate 12 and side plate 14 of the metal housing as well as the partition plate 13 can be processed by one-piece molding, such as cast molding, to meet requirements of the mass production. Naturally, each part of the metal housing and the partition plate 13 may also be fixedly connected into one-piece by other methods, for example welding, screw fastening, etc.

FIG. 3 is a cutaway view of the phase shifter along a line A-A in FIG. 2. In each chamber 15, two parallel-arranged metal guide sleeves 21 and a U-shaped conductor 22 are set. The two free ends of the U-shaped conductor 22 are respectively inserted into the two metal guide sleeves 21, and the free ends of the U-shaped conductor 22 can move relatively to the metal guide sleeves 21. The metal guide sleeves 21 and the U-shaped conductor 22 form a successive stripline.

The bended end of the U-shaped conductor 22 is connected with an insulation draw rod 23. One end of the insulation draw rod 23 is fixedly connected to the bended end of the U-shaped conductor 22, and the other end of the insulation draw rod 23 extends out of the metal housing and is connected to a driving apparatus outside of the metal housing. The insulation draw rod 23 is actuated by the driving apparatus to move along the metal guide sleeves 21. In turn, the U-shaped conductor 22 moves relatively to the metal guide sleeves 21 to adjust the length of the U-shaped conductor 22 embedded inside the metal guide sleeves 21, so as to change the actual length of the stripline transmission path and thus to change the signal transmission phase.

Each chamber 15 includes an insulation guide 24 and an insulation support (not shown in the drawings). The insulation guide 24 is fixed to the end of the chamber 15. A positioning hole is set in the insulation guide 24, and the insulation draw rod 23 passes through the positioning hole to be connected with the driving apparatus outside of the metal housing. The positioning hole is used for supporting and limiting the insulation draw rod 23 so as to ensure the stationarity when the insulation draw rod 23 moves relatively to the insulation guide 24, and to further control the position and the height of the U-shaped conductor 22 when moving, thereby to ensure that the impedance matching characteristics of the stripline is unchanged.

The insulation support is provided between the partition plate 13 and the upper cover plate 11 and between the partition plate 13 and the lower bottom plate 12 to support the partition plate 13. The partition plate 13 is supported between the upper cover plate 11 and the lower bottom plate 12 by the insulation support to form the layered chambers 15. Preferably, the insulation support and the insulation guide 24 are formed as one-piece fixed to the end of the chamber 15. In order to prevent the metal guide sleeves 21 from displacing, metal guide sleeves 21 may also be fixed into the chamber 15 via the insulation support.

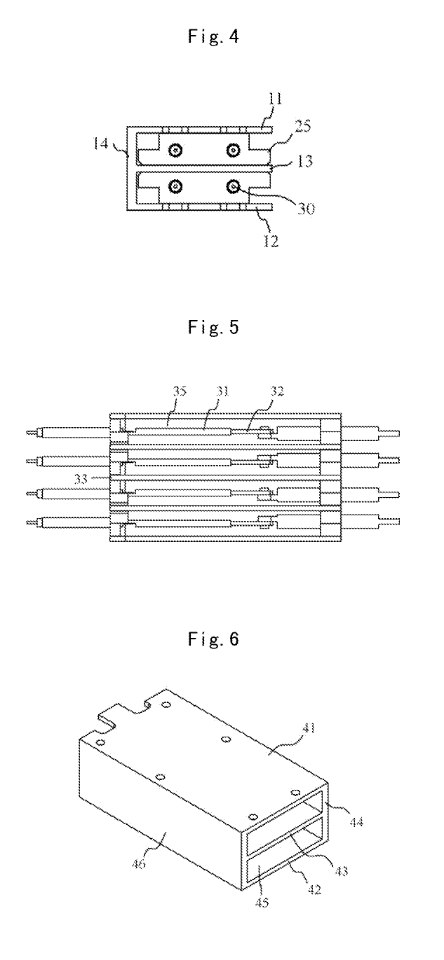

FIG. 4 is a left side view of the phase shifter shown in FIG. 1 . Each chamber 15 further includes a connecting portion 25 provided on the other end of the chamber 15. The central wire of a coaxial cable 30 passes through the connecting portion 25 to be connected with the metal guide sleeve 21, while an outer conductor of the coaxial cable 30 is connected with the metal housing via the connecting portion 25, thereby forming the desired stripline structure. The connecting portion 25 is made of metal, which may also function to support the partition plate 13.

The insulation process is performed on the surfaces of the two metal guide sleeves 21 and the U-shaped conductor 22 to avoid affecting the electrical property sub-intermodulation so as to ensure good sub-intermodulation characteristics.

In addition, the insulation draw rods 23 of two or more layers in a plurality of layered chambers 15 may be connected to each other via the insulation connecting rod (not shown in the drawings). Thus, the phase variation of two or more radiating elements may be controlled simultaneously such that the entire control system may be simplified and in turn the cost can be controlled.

FIG. 5 is a structurally schematic view of a second embodiment of a phase shifter of the present invention. The phase shifter of this embodiment comprises four layered phase shifter units, i.e. a metal housing is divided into four layered chambers 35 by using three partition plates 33. In each chamber 35, two parallel-arranged metal guide sleeves 31 and a U-shaped conductor 32 are set. Further, two free ends of the U-shaped conductor 32 are respectively inserted into the two metal guide sleeves 31, and the free ends of the U-shaped conductor 32 move relatively to the metal guide sleeves 31 so as to change a phase of an output signal of the phase shifter.

FIG. 6 is a structurally schematic view of a third embodiment of a phase shifter of the present invention. The phase shifter of this embodiment comprises an upper cover plate 41, a lower bottom plate 42, a first side plate 44, a second side plate 46 and a partition plate 43. The upper cover plate 41, the lower bottom plate 42, the first side plate 44, the second side plate 46 and the partition plate 43 are each made of metal. The upper cover plate 41 and the lower bottom plate 42 are provided so as to be parallel to each other and perpendicular to the first side plate 44 and the second side plate 46. The upper cover plate 41, the lower bottom plate 42, the first side plate 44 and the second side plate 46 of the phase shifter form a metal housing. The partition plate 43 is provided between the upper cover plate 41 and the lower bottom plate 42 and is perpendicular to the side plate 44 so as to divide the metal housing into two enclosed chambers 45. The metal housing according to the embodiment shown in FIG. 6 is a variant of the metal housing shown in FIG. 1. Since the arrangement of other parts of the phase shifter including this metal housing is the same as the phase shifter described above, the description thereof is omitted here.

A phase shifter of a fourth embodiment of the present invention comprises an upper cover plate, a lower bottom plate, a partition plate and an insulation support. The upper cover plate, the lower bottom plate and the partition plate are provided so as to be parallel to each other. Further, the partition plate is provided between the upper cover plate and the lower bottom plate. The partition plate is supported between the upper cover plate and the lower bottom plate by the insulation support to form two layered chambers.

Comparing with the prior art, the phase shifter of the present invention comprises at least two layered phase shifter units. The phase variation of a plurality of radiating elements is centralized-controlled by the layered phase shifter units, so as to enable the high integration level of the phase shifter and enable the phase control of each radiating element to be very convenient. The phase shifter of the present invention, with simple structure, low cost and phase shifting effect of high quality, can be applied widely in the feeding network of the phased antenna array in order to control the vertical beam and/or the horizontal beam of the antenna, such that the present invention provides better flexibility for the mobile telephone network to optimize the system performance.

The above embodiments are exemplary embodiments of the invention and are not used to limit the present invention. The protection scope of the invention is defined by the appended claims. Those skilled in the art may make various modifications or equivalent alterations without departing from the protection scope of the invention. These modifications or equivalent alterations should fall within the protection scope the invention.

What is claimed is:

1. A phase shifter, characterized in that the phase shifter comprises at least two layered chambers, wherein in each chamber two parallel-arranged metal guide sleeves and a U-shaped conductor are set, two free ends of the U-shaped conductor are respectively inserted into the two metal guide sleeves, and the free ends of the U-shaped conductor move relatively to the metal guide sleeves so as to change a phase of an output signal of the phase shifter.

2. The phase shifter according to claim 1, characterized in that the phase shifter includes a metal housing divided into the layered chambers by a metal partition plate.

3. The phase shifter according to claim 2, characterized in that each of the chambers further includes an insulation support for supporting the metal partition plate.

4. The phase shifter according to claim 1, characterized in that the phase shifter includes an upper cover plate, a lower bottom plate, a side plate and at least one metal partition plate; the upper cover plate, the lower bottom plate and the side plate form a metal housing; and the metal housing is divided into the layered chambers by the metal partition plate.

5. The phase shifter according to claim 4, characterized in that the metal housing is divided as an E-shaped metal housing by the metal partition plate.

6. The phase shifter according to claim 1, characterized in that the phase shifter includes an insulation draw rod, by which the U-shaped conductor is actuated to move relatively to the metal guide sleeves.

7. The phase shifter according to claim 6, characterized in that each of the chambers further includes an insulation guide for positioning the insulation draw rod.

8. The phase shifter according to claim 1, characterized in that an insulation process is performed on the surfaces of the metal guide sleeves and the U-shaped conductor.

9. The phase shifter according to claim 1, characterized in that the chambers are enclosed.

10. The phase shifter according to claim 1, characterized in that the phase shifter includes an upper cover plate, a lower bottom plate, an insulation support and at least one metal partition plate, and the metal partition plate is supported between the upper cover plate and the lower bottom plate by the insulation support so as to form the layered chambers.

11. A phase shifter, characterized in that the phase shifter comprises at least two layered phase shifter units, wherein in each phase shifter unit two parallel-arranged metal guide sleeves and a U-shaped conductor are set, two free ends of the U-shaped conductor are respectively inserted into the two metal guide sleeves, and the free ends of the U-shaped conductor move relatively to the metal guide sleeves so as to change a phase of an output signal of the phase shifter.
